(19) United States
(12) Patent Application Publication
(10) Pub. No.: US 2014/0286563 A1
(43) Pub. Date: Sep. 25, 2014

(54) ACCURATE DETECTION OF LOW-CONTRAST DEFECTS IN TRANSPARENT MATERIAL

(71) Applicant: Industrial Video Solutions, Inc., Vienna, VA (US)

(72) Inventors: Slawek Frackowiak, Vienna, VA (US); Les Frackowiak, Vienna, VA (US)

(73) Assignee: INDUSTRIAL VIDEO SOLUTIONS, INC., Vienna, VA (US)

(21) Appl. No.: 14/218,335

(22) Filed: Mar. 18, 2014

Related U.S. Application Data
(60) Provisional application No. 61/803,150, filed on Mar. 19, 2013.

(51) Int. Cl. G06T 7/00

(52) U.S. Cl. CPC G06T 7/0004
USPC 382/141

(57) ABSTRACT

This invention relates to a method and apparatus for detection of low-contrast defects in transparent materials such as plastics or glass. The method relies on the illumination of the material with a light producing a contrasting pattern, which accentuates defects. The method also includes the removal of the contrasting pattern either digitally with a pattern filtering algorithm or by the specific placement of the camera view. The apparatus involves one or many cameras positioned on one side of the material, one or many lights producing the desired pattern and positioned on the other of the material, and a computer or other computing device using an algorithm to process the image.

### CROSS REFERENCE TO RELATED APPLICATION

This application claims the priority of U.S. provisional patent application No. 61/803,150 submitted on Mar. 19, 2013, entitled “Method and Apparatus for Detection of Defects in Transparent and Semi-Transparent Sheet Material” the contents of which are relied upon and incorporated herein by reference in their entirety, and the benefit of priority under 35 U.S.C. 119(e) is hereby claimed.

### FIELD OF THE INVENTION

This invention relates to the detection of low-contrast defects in transparent material, and more particularly, to the accurate detection obtained by increasing contrast between a defect and the defect-free background.

### DESCRIPTION OF THE PRIOR ART

Transparent materials are widely manufactured worldwide. Examples of such materials include rigid and flexible plastics, and glass. Depending on the stage of the process, different forms of the said material can be produced. For example, flexible plastic could be manufactured as a web and later processed into bags, pouches, etc. Rigid plastic could be manufactured directly into the end product, such as bottles and containers.

The manufacturing process is not perfect and often results in defects such as gels, holes, scratches, lumps, discolorations, foreign materials, etc. Some defects (e.g., foreign materials) can be easily detected with a human eye or a camera-based system while others are difficult or even impossible to detect because of the low contrast between the defect and the background (e.g., gels and small holes in plastic).

Defect detection systems use cameras and lights to capture either still images or video and analyze the captured images to detect defects. Many such systems are commercially available. The deficiency of prior art defect detection systems is that certain defects, while important to the material manufacturer and/or end-user, can be left undetected because of their low contrast. Quite often, regardless of the availability of defect detection systems, many manufacturers use skilled workers to manually inspect the final product to ensure accurate detection of gels and other low-contrast defects.

### SUMMARY OF THE INVENTION

A system for detection of low-contrast defects in transparent materials such as plastic foil or glass. The said materials are referred to hereinafter as material. The system consists of:

one or multiple cameras located on one side of the material. Depending on the manufacturing process, the cameras can be either area-scan or line-scan type;

one or multiple lights capable of projecting a contrasting pattern on the material. The lights are located on the opposite side of the material from the camera;

one or multiple processors (such as computers and FPGA's) capable of executing code required to capture and process images or video in order to accurately detect and report low-contrast defects.

A method for detection of low-contrast defects in the material. The method has the steps of:

superimposing a controlled contrast pattern on the image of the material. The pattern consist of at least one each of darker and lighter areas. This alternating pattern accentuates the defects by showing them as darker spots over the lighter area and lighter spots over the darker area;

using a camera to capture the image of the material with the superimposed pattern;

removing the pattern from the image without removing the defect representation. The pattern can be removed digitally with a pattern filtering algorithm or by the specific placement of the camera view;

the resulting image is further enhanced and thresholded to identify defects.

### BRIEF DESCRIPTION OF THE SEVERAL VIEWS OF THE DRAWING

FIG. 1A shows the elevation and FIG. 1B shows the top view of the preferred embodiment used for inspection of the plastic foil manufacturing process.

FIG. 2 shows the area scan camera image representation of the material with a superimposed contrast pattern and no defect present.

FIG. 3 shows the area scan camera image representation of the material with a superimposed contrast pattern and the defect present.

FIGS. 4 and 5 illustrate light refraction in the material according to Snell's Law, with and without the defect.

### DETAILED DESCRIPTION OF THE INVENTION

The present invention has several embodiments depending on the type of process and manufactured material. In one possible embodiment, an area-scan camera is used to inspect a web manufacturing process. In another embodiment, a line-san camera is used to inspect the same process.

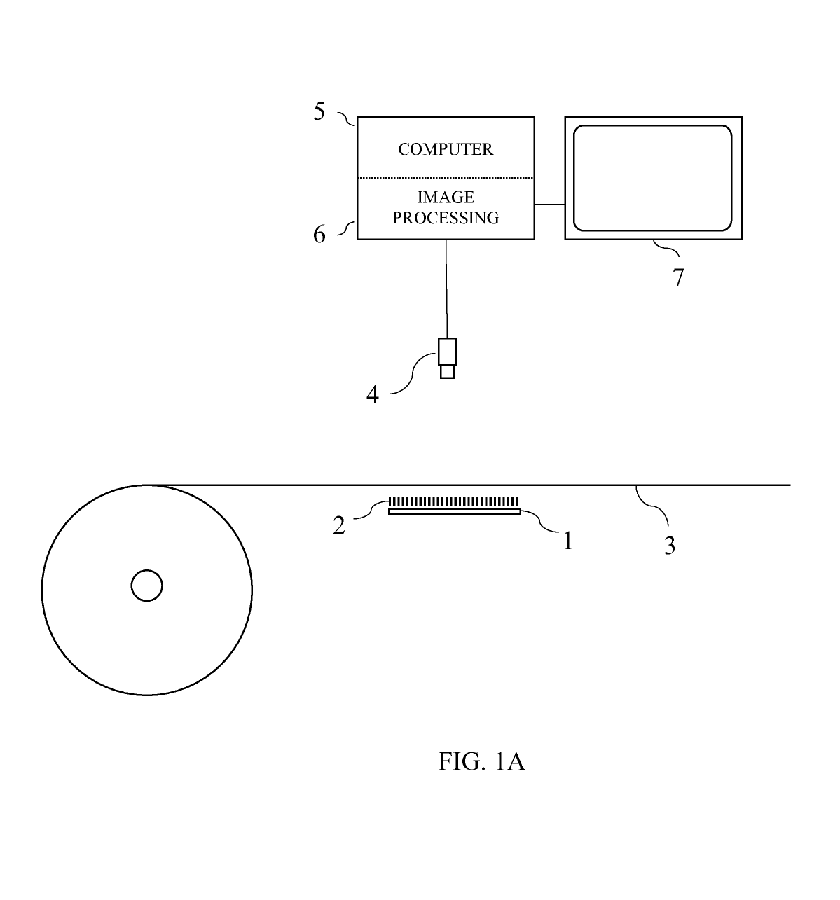

FIG. 1A shows the elevation and FIG. 1B shows the top view of the preferred embodiment used for inspection of a web manufacturing process. The inspection station consists of a light (1) projecting a contrasting pattern (2) onto the manufactured material (3). An area scan camera (4) is located on the opposite side of the material from the light. A computer or other computing device (5) running an image processing algorithm (6) captures images and removes the pattern from the image without removing the defect representation. Consequently, the defect's contrast is sufficiently increased such that the defect can be accurately identified. The results of the analysis can optionally be presented on a monitor (7).

For the sake of simplicity, the preferred embodiment uses a striped pattern of alternating opaque (darker, as perceived by the camera) and transparent (lighter, as perceived by the camera) stripes of constant size. Alternative embodiments can use any pattern as long as a suitable pattern removal algorithm or specific camera view placement is used.

In the preferred embodiment, the planes of the light projecting the striped pattern (1, 2), the material (3), and the camera (4) are all parallel. The camera is focused at the plane of the material (3) and the width of the stripes in the pattern (2) is selected to match the required detection accuracy. The distance from the patterned light (1, 2) to the material (3) is adjusted accordingly.

An alternative embodiment can be used for inspection of the same process as the preferred embodiment with line-scan cameras. The line scan camera is placed such that the imaging occurs in the lighter area between two darker stripes or in the darker area between two lighter stripes, which eliminates the need for the pattern removal algorithm. Depending on the location of the imaging line, the defect will appear as dark spot over the light background or a light spot over the dark background.

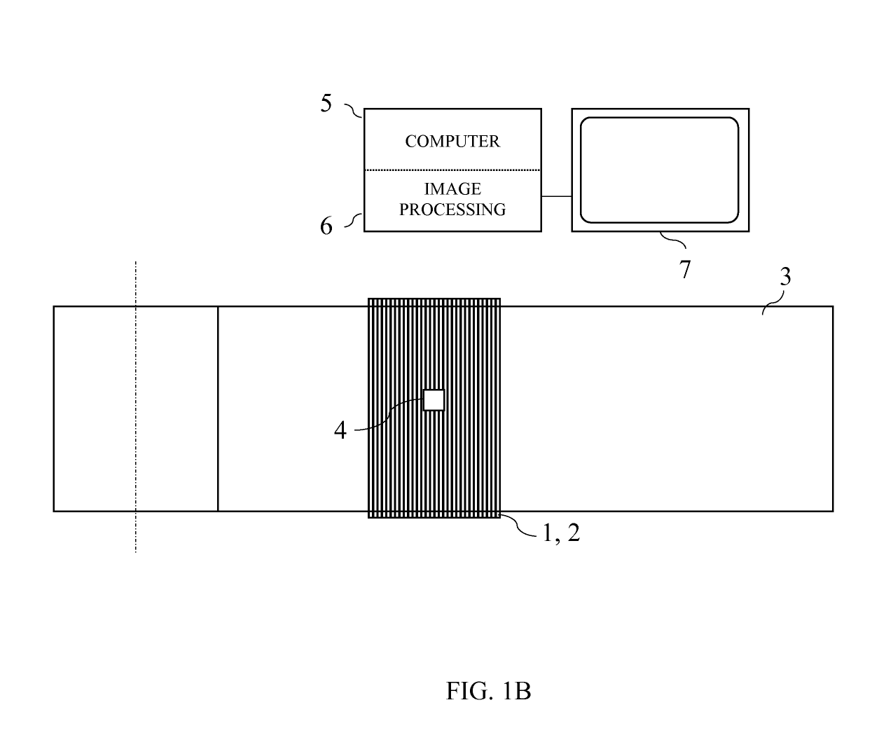

The method used in this invention utilizes the contrasting pattern to accentuate the image of the defect. A perfectly flat, defect-free material arranged as per FIG. 1A and FIG. 1B will appear to the camera as having exactly the same pattern (8) as the contrasting pattern because the light rays pass through the material without changing direction (9), as shown in FIG. 2.

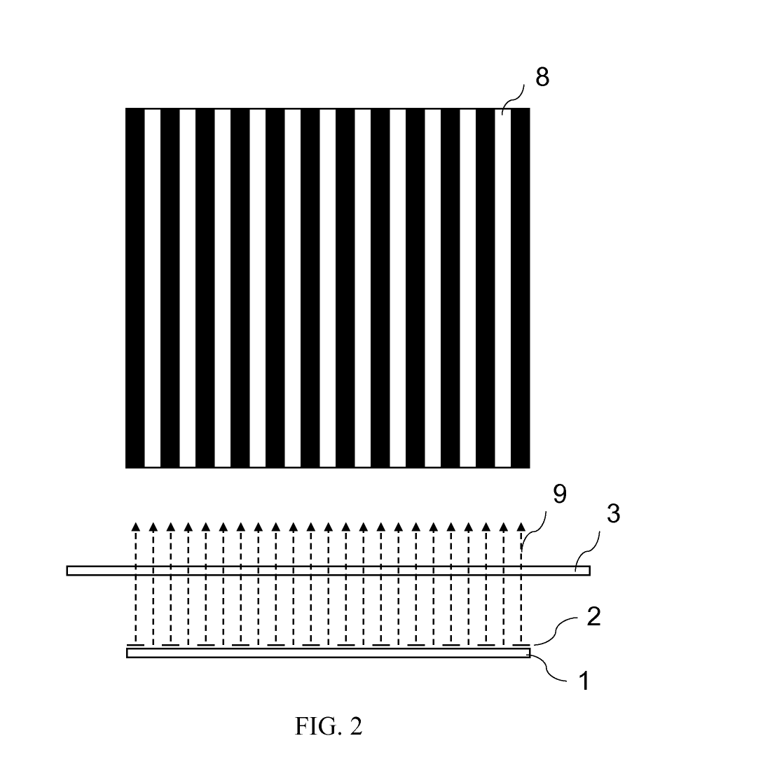

When the material contains a defect (10), as shown in FIG. 3, the light rays that cross the defect (11) are refracted (12), causing rays from outside of the defect area (13) to appear in the defect area (14), and in effect, producing an image of the defect superimposed on the image of the striped pattern (15). Depending on the defect location and its geometry, the image of the defect can take different shape, but it will appear as either a darker spot over the area of the lighter pattern, a lighter spot over the area of the darker pattern, or a combination of dark and light spots when the defect image falls at the boundary between dark and light areas.

This behavior is explained by Snell's Law governing the propagation of light through the interface between two different media and is given by

n₁*sin(Θᵢ)=n₂*sin(Θᵣ)

Where Θᵢ is the angle between the incident ray and the normal to the interface between media, Θᵣ is the angle between the refracted ray and the normal to the interface between media, n₁ is the refractive index of the first media, and n₂ is the refractive index of the second media.

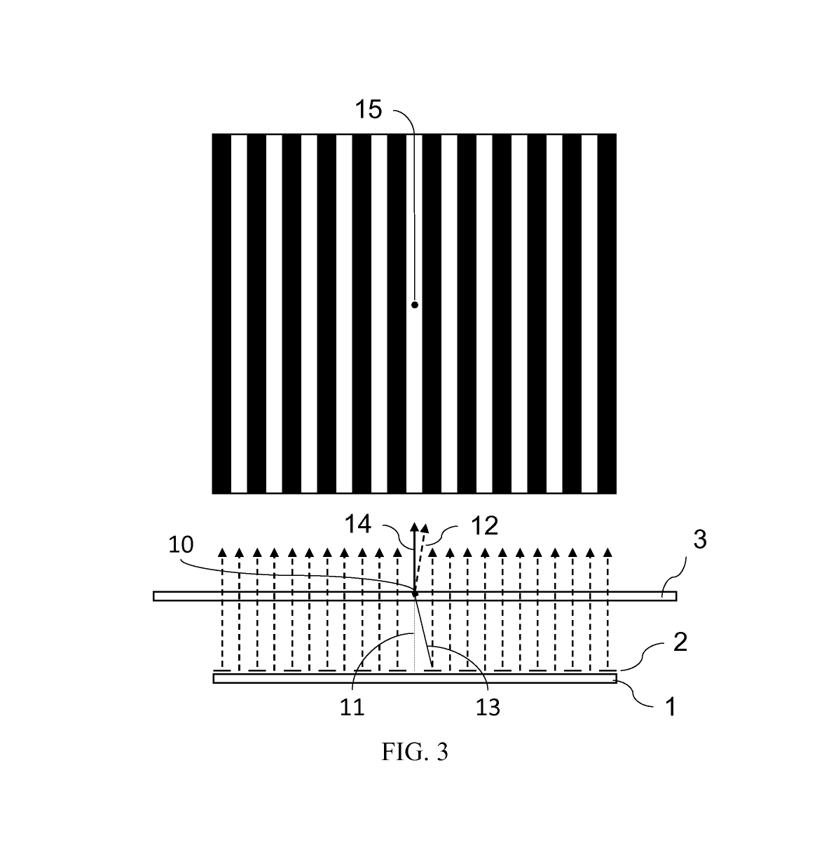

A perfectly flat and defect-free material (16), as shown in FIG. 4, will transmit the light rays without changing their direction (17) because Θᵢ=0° and thus Θᵣ=0° .

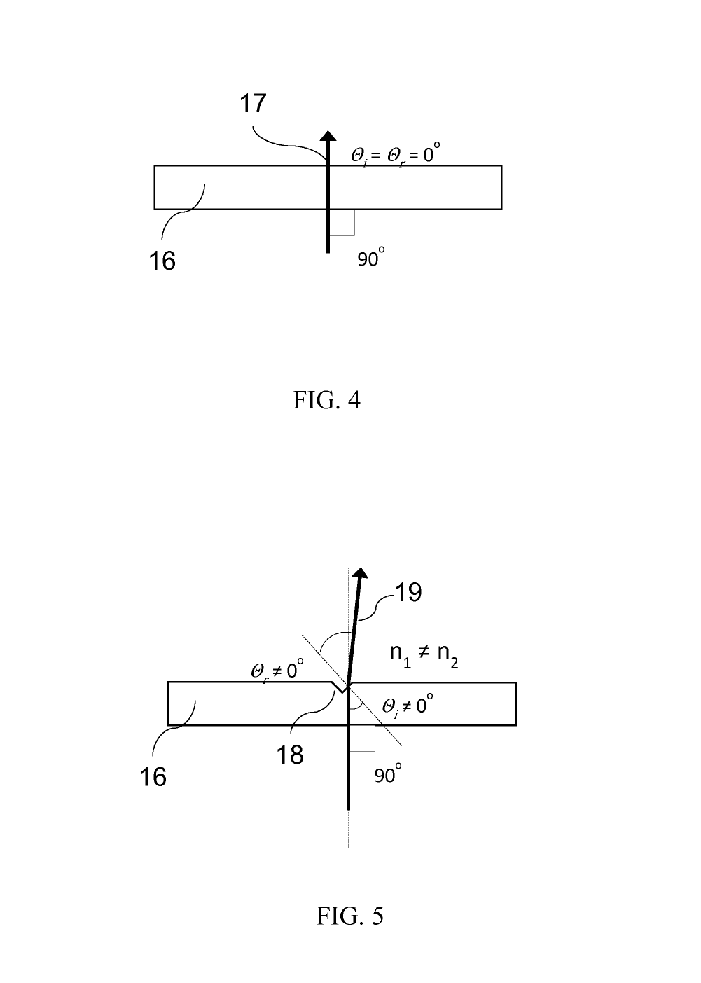

In FIG. 5, when the material (16) contains a defect, illustrated as a simple surface defect (18), the light rays will refract (19) at the defect boundary because Θᵢ>0° and n₁≠n₂.

When the material containing a defect is observed by the camera in configurations shown in FIG. 1A and FIG. 1B, but without a contrasting pattern, the defect might not be seen at all or might only be seen as a faint darker spot. The darker spot is caused by less light reaching the camera from the defect area because some of the light is refracted away from the camera.

When a contrasting pattern is applied, the same defect can clearly be seen because some of the refracted rays are superimposed over the contrasting areas (dark over light or light over dark).

Different algorithms can be used to remove the pattern from the camera image without removing the defect representation. One such algorithm is line filtering. The line filtering algorithm averages the captured image line-by-line by replacing each pixel's grayscale value with the mean value of a number of pixels before and after the analyzed pixel. Then, the filtered image is subtracted from the original image, which removes the linear pattern while retaining the representation of the defect.

What is claimed is:

1. A method and apparatus for detecting low-contrast defects in transparent material comprising of:
A light projecting a contrasting pattern located on one side of the material,
An area-scan or line-scan camera located at the opposite side of the material from the light and focused on the material,
A computing device capable of processing images captured by the camera,
An image processing algorithm.

2. A method wherein the contrasting pattern of claim 1 is superimposed on the material image to accentuate defects.

3. A method wherein the image processing algorithm of claim 1 has the capability of removing the contrasting pattern from the image produced as the result of claim 2, without removing the defect representation.

4. A method wherein the camera of claim 1 is placed over a portion of the material in which the pattern does not vary, thus eliminating the need for the pattern removal algorithm, but retaining the defect representation that is achieved in claims 2 and 3.
